(19) United States
(12) Patent Application Publication
(10) Pub. No.: US 2026/0188790 A1
(43) Pub. Date: Jul. 2, 2026

(54) HEATSINK FOR THERMAL MANAGEMENT OF BATTERY MODULE ELECTRONICS

(71) Applicant: Wisk Aero LLC, Mountain View, CA (US)

(72) Inventors: Anthony Courville, Mountain View, CA (US); Sytse Tacoma, Christchurch (NZ); Jacob Ryser, Mesa, AZ (US)

(73) Assignee: Wisk Aero LLC, Mountain View, CA (US)

(21) Appl. No.: 19/345,395

(22) Filed: Sep. 30, 2025

Related U.S. Application Data
(60) Provisional application No. 63/739,802, filed on Dec. 30, 2024.
(60) Provisional application No. 63/768,758, filed on Mar. 7, 2025.

(51) Int. Cl. H01M 10/667; H01M 10/42; H01M 10/653; H01M 10/6556; H01M 50/258; H01M 50/287

(52) U.S. Cl. CPC H01M 10/667; H01M 10/4257; H01M 10/653; H01M 10/6556; H01M 50/258; H01M 50/287; H01M 2010/4271

(57) ABSTRACT

A battery module assembly may include a module chassis. The module chassis may include a first end plate, a second end plate, and a plurality of panels arranged in parallel to one another. First ends of the plurality of panels may be connected to the first end plate. Second ends of the plurality of panels may be connected to the second end plate. The module chassis may be adapted to hold a plurality of battery cells between the first end plate, the second end plate, and the plurality of panels. The battery module assembly may include an electronic component (e.g., DC/DC converter) abutted against the module chassis. The module chassis may be adapted to dissipate heat generated by the electronic component through the plurality of battery cells.

### CROSS-REFERENCES TO RELATED APPLICATIONS

This application is a non-provisional of, and claims priority to, U.S. Provisional Ser. No. 63/739,802, filed Dec. 30, 2024, and U.S. Provisional Ser. No. 63/768,758, filed Mar. 7, 2025, each of which is incorporated herein by reference in its entirety for all purposes.

### BACKGROUND

Electric vehicle (EV) powertrains, no matter the application, require a low voltage (LV) bus to run the onboard systems and control the high voltage (HV) supply. Direct-current-to-direct-current (DC/DC) converters may provide aircraft with LV power from a HV supply. DC/DC converters, along with most printed circuit board (PCB) electronics, are not 100% efficient, and they generate heat energy. LV generators, such as DC/DC converters, are typically in a separate enclosure and mounted onto a heat sink of some kind. Usually, it is either a liquid or air-cooled cold plate. These solutions are mass-prohibitive and volume-prohibitive in many implementations, including many aircraft implementations such as electric vertical take-off and landing (eVTOL) implementations. This poses a problem as the heat energy needs to go somewhere within the module to avoid overheating, and there is no active cooling available during flight.

Thus, there is a need for systems and methods that address the foregoing problems in order to provide more efficient and relatively lightweight solutions. This and other needs are addressed by the present disclosure.

### SUMMARY

Certain embodiments of the present disclosure relate generally to battery modules, and more particularly to heatsink for thermal management of battery module electronics.

In one aspect, a battery module assembly may include a module chassis. The module chassis may include a first end plate, a second end plate, and a plurality of panels arranged in parallel to one another. First ends of the plurality of panels may be connected to the first end plate. Second ends of the plurality of panels may be connected to the second end plate. The module chassis may be adapted to hold a plurality of battery cells between the first end plate, the second end plate, and the plurality of panels. The battery module assembly may include an electronic component abutted against the module chassis. The module chassis may be adapted to dissipate heat generated by the electronic component through the plurality of battery cells.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by either following the reference label by a dash and a second label that distinguishes among the similar components or following the reference label by parentheses enclosing a second label that distinguishes among the similar components. If only the first reference label is used in the specification, the description is applicable to any one of the similar components having the same first reference label irrespective of the second reference label.

FIG. 1A illustrates a simplified, isometric view of an example battery pack, in accordance with embodiments according to the present disclosure.

FIG. 1B illustrates an exploded, isometric view of the battery pack, in accordance with embodiments according to the present disclosure.

FIG. 2 depicts a cross-section of at least part of an example module chassis, in accordance with embodiments according to the present disclosure.

FIG. 3 depicts a perspective view of at least part of the example module chassis, in accordance with embodiments according to the present disclosure.

FIG. 4 illustrates a diagram of at least part of the module chassis, in accordance with embodiments according to the present disclosure.

FIG. 5 illustrates another view of the module chassis illustrating a floor panel adapted to support a cumulative battery cell mass, in accordance with embodiments according to the present disclosure.

FIG. 6 illustrates a top view of an example module chassis providing battery cell compression, in accordance with embodiments according to the present disclosure.

FIG. 7 illustrates a billet plate of an end plate assembly, in accordance with embodiments according to the present disclosure.

FIG. 8 illustrates another view of the module chassis with the billet plate of the end plate assembly exposed, in accordance with embodiments according to the present disclosure.

FIG. 9 illustrates a view of the module chassis with the billet plate attached, in accordance with embodiments according to the present disclosure.

FIG. 10 illustrates fluid paths through the module chassis, in accordance with embodiments according to the present disclosure.

FIG. 11 illustrates models of the temperature contours of part of a cold plate assembly and of battery cells, in accordance with embodiments according to the present disclosure.

FIG. 12 illustrates a view of the front portion of the module chassis, in accordance with embodiments according to the present disclosure.

FIG. 13 illustrates a cross-section of a spring-loaded mount assembly for mounting the DC/DC converter, in accordance with embodiments according to the present disclosure.

FIG. 14 illustrates a partial cross-section view of a battery module assembly, in accordance with embodiments according to the present disclosure.

FIG. 15 illustrates another partial cross-section view of a battery module assembly, in accordance with embodiments according to the present disclosure.

FIG. 16 illustrates example test results for the battery module assembly during charging, in accordance with embodiments according to the present disclosure.

FIG. 17 illustrates alternative DC/DC converter implementations with a battery module assembly, in accordance with embodiments according to the present disclosure.

FIG. 18 illustrates an example method for forming a module chassis assembly and dissipating heat generated by electronics with the module chassis assembly, in accordance with embodiments according to the present disclosure.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Electric vehicle (EV) powertrains, no matter the application, require a low voltage (LV) bus to run the onboard systems and control the high voltage (HV) supply. Embodiments according to the present disclosure may provide for means to provide aircraft with LV power by employing a distributed fleet of direct-current-to-direct-current (DC/DC) converters. Each module (e.g., line replaceable unit (LRU)) may be fitted with a DC/DC converter supplied directly by the module terminal voltage (high voltage) that is transformed into a low voltage output. There are 72 modules and, thus, 72 independent sources of LV power with a distributed network of DC/DC converters. This differs from more traditional HV/LV architectures, where LV is generated from a concentrated source, typically a separate enclosure supplied from the battery HV bus voltage. The HV/LV architecture has the benefit of elevated failure tolerance and redundancy.

DC/DC converters, along with most printed circuit board (PCB) electronics, are not 100% efficient, and they generate heat energy. LV generators, such as DC/DC converters, are typically in a separate enclosure and mounted onto a heat sink of some kind. Usually, it is either a liquid or air-cooled cold plate. These solutions are mass-prohibitive and volume-prohibitive in many implementations, including many aircraft implementations such as electric vertical take-off and landing (eVTOL) implementations. This poses a problem as the heat energy needs to go somewhere within the module to avoid overheating, and there is no active cooling available during flight.

Embodiments according to the present disclosure may provide for the thermal management of heat sources within a module with a DC/DC converter as an example. Embodiments according to the present disclosure may use battery cells and a battery module chassis as a heat sink for thermal energy generated by a DC/DC converter or other electronics. The battery cells and the battery module chassis may correspond to multi-functional components. In thermal Finite Element Analysis (FEA) and lab testing, the battery cells may have enough thermal capacity within them to not only support their own resistive heating during flight but also to absorb the DC/DC heat energy and maintain temperatures within acceptable cell temperature limits. For example, the temperature gradient within any individual cell may not deviate by more than 10° C. at any given time under normal operation throughout the life of the battery module.

In various examples, disclosed embodiments may be used in cases where a battery system calls for heat dissipation at the module level. In various examples, disclosed embodiments may be used in cases where a battery needs LV and LV is generated in close proximity to the base cells. In various examples, disclosed embodiments may be used with many different sources of heat generation including battery management system (BMS) boards and balance resistor boards. Disclosed embodiments may be used in various eVTOLs and ground-based vehicles (e.g., autonomous cars) to take advantage of the HV/LV architecture, increasing their LV redundancy while maintaining operational thermal management of the PCB electronics. Disclosed embodiments may reduce battery mass and volume can be used for many traction applications, for several form factors, including pouch, cylindrical, and prismatic batteries.

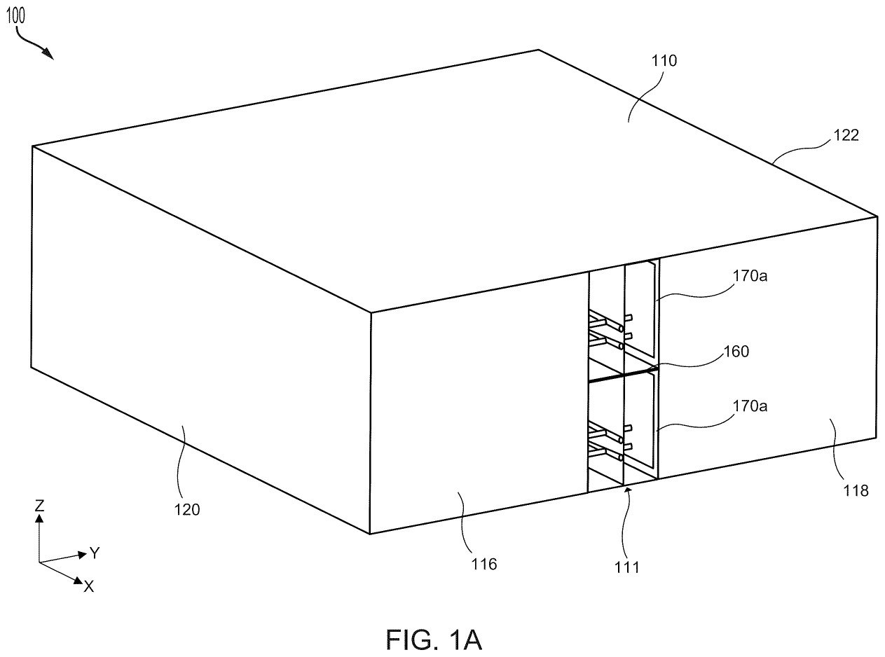

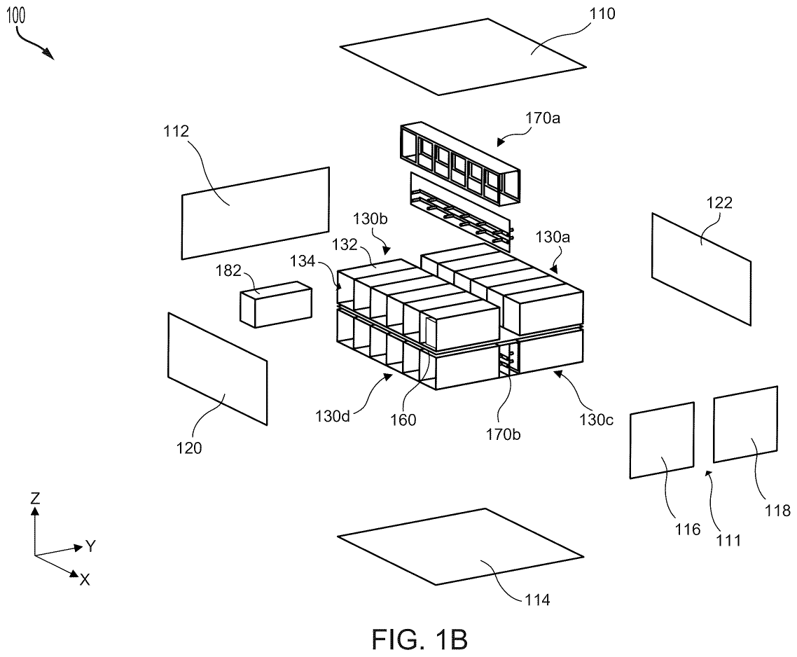

Various embodiments will now be discussed in greater detail with reference to the accompanying figures, beginning with FIGS. 1A and 1B.

FIGS. 1A and 1B depict an example battery pack 100, in accordance with embodiments according to the present disclosure. With specific reference to FIG. 1B, the battery pack 100 can define an enclosure formed by a first panel 110, a second panel 112, a third panel 114, a fourth panel 116, a fifth panel 118, a first sidewall 120, and a second sidewall 122. The panels 112, 114, 116, 118 may be coupled together (e.g., via welding, brazing, soldering, gluing, fastening, or the like) to define an interior volume. The panels 110, 112, 114, 116, 118 and sidewalls 120, 122 may define the enclosure to have a substantially cuboid structure, however, in other embodiments, the enclosure may have other shapes, such as being pyramid, spherical, or the like. It should be understood that, for the sake of visual clarity, the battery pack 100 may include additional components not depicted in FIGS. 1A and 1B.

The interior volume may house internal components of the battery pack 100, such as sets of battery modules 132. For example, the enclosure may house a first module row 130a of battery modules 132, a second module row 130b of battery modules 132, a third module row 130c of battery modules 132, and a fourth module row 130d of battery modules 132. Each battery module 132 may define a battery volume 134 sized and shaped to house a grouping 182 of battery cells. Each grouping 182 of battery cells can include battery cells grouped together in a stacked configuration, wound configuration, or the like. Although each module row 130a, 130b, 130c, 130d is depicted as including six battery modules 132, in other embodiments, one or more of the module rows can have more or less than six battery modules, such as four battery modules, five battery modules, seven battery modules, eight battery modules, or the like. In other embodiments, the battery modules of each module row may not be oriented in a linear row but, instead, may be oriented as a set of battery modules in a set of non-linear orientation.

The battery pack 100 can include a first venting system 170a positioned between the module rows 130a, 130b and a second venting system 170b positioned between the module rows 130c, 130d. The battery modules 132 of each of the module rows 130a, 130b, 130c, 130d may be coupled to the corresponding venting system 170a, 170b (e.g., via welding, brazing, soldering, gluing, fastening, or the like) such that an airtight seal is formed between each battery module 132 and the corresponding venting system 170a, 170b. The battery modules 132 may be coupled directly with the corresponding venting system 170a, 170b to form this airtight seal. However, in other embodiments, one or more intervening component(s) (e.g., including a gasket, seal ring, or the like) may be positioned between the battery module and the corresponding venting system to form the airtight seal. The first venting system 170a can be in fluid communication with the module rows 130a, 130b through the airtight seal such that effluent discharge may flow through the first venting system 170a and an exit opening 111 defined between the panels 116, 118 to exterior of the battery pack 100. The second venting system 170b can be in fluid communication with the module rows 130c, 130d through the airtight seal such that effluent discharge may flow through the second venting system 170b and the exit opening 111 defined between the panels 116, 118 to exterior of the battery pack 100.

The battery cells may typically be quite small, and thousands of them may be used to build a battery. For example, the majority of all Li-ion battery systems ever conceived may consist of base cells arranged into a subassembly that is welded together, commonly referred to as a module, a brick, or a sub-module. The battery cells illustrated in some of the figures may correspond to pouch cells. However, other embodiments may use other forms of battery cells, such as cylindrical cells.

The individual battery cells need to be supported in space with a structural load path. Further, most batteries need some level of operational cooling to achieve better performance, especially when discharge and charge rates are increased. Fluid cooling may be more common than air cooling. Additionally, the battery cells need to be under pressure for better performance. For example, Li-ion cells, no matter what the form factor, type, or battery architecture, may require three key cell requirements: 1) cell compression (to keep the anode, cathode, and separator from expanding and delaminating); 2) structural load path (to transfer the mass load of the cells to the wider structure); and 3) operational thermal cooling (most commonly achieved by a fluid coolant).

Embodiments of a module chassis according to the present disclosure may provide for all three key cell requirements into a single, integrated element. That is, embodiments may provide for a structural load path, as well as cooling, while providing for cell compression. Disclosed embodiments may apply to use cases any time a battery includes pouch cells and requires fluid cooling. The structural support provided by embodiments may include supporting the weight of the battery cells, mounting the modules, and supporting compression of the battery cells. Accordingly, embodiments may provide for preload on the cells.

Conventional battery designs, by contrast, address the requirements separately with a structure to hold the battery cells and a separate cold plate through which fluid is pumped. However, the separate structures approach is heavy because of the amount of material needed for the separate structures. There are many examples of conventional batteries, both across electric vertical take-off and landing (eVTOL) aircraft and automotive. However, none have an integrated solution where the coolant channels are built into the structural element as in the module chassis according to embodiments of the present disclosure. Instead, the cold plate is usually a stand-alone part, and the structural members are separate in conventional approaches.

Embodiments according to the present disclosure may provide for a module chassis that includes a structural cold plate, an element that not only cools the cells but also supports them with the same pieces that may, for example, be made of aluminum. Embodiments of the module chassis may include extruded cold plates brazed to machined end plates, which together form a hollow, sealed structure that can pass fluid through. In some embodiments, the plates may be made of aluminum. The integrated part is reinforced by bonding composite panels (e.g., strengthened with carbon fiber) to the walls and floor to handle static and dynamic loads. Without reinforcing, an aluminum-brazed cold plate may not be strong enough. The module chassis according to disclosed embodiments significantly cuts down on system mass, a key performance metric for any traction application. Minimizing weight is not only important for aircraft but also for ground-based electric vehicles. Cumulatively, in a system including 72 battery modules, for example, the savings may be multiplied by 72. Advantageously, disclosed embodiments may also allow for a reduced part count, as well as for savings on complexity and cost. Disclosed embodiments may apply to traction batteries for automotive and aviation implementations. Disclosed embodiments may apply to any implementation where battery mass is a driver.

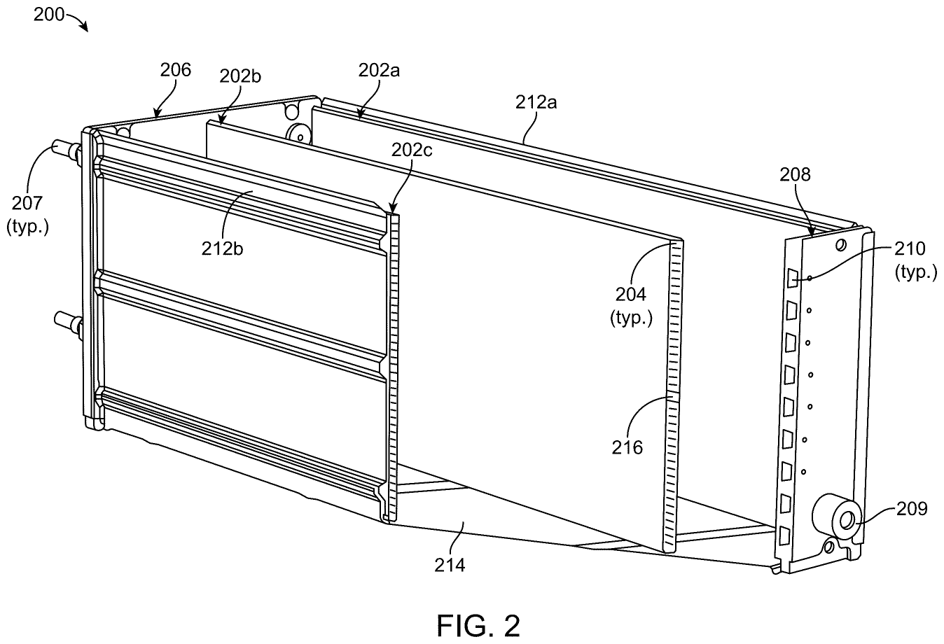

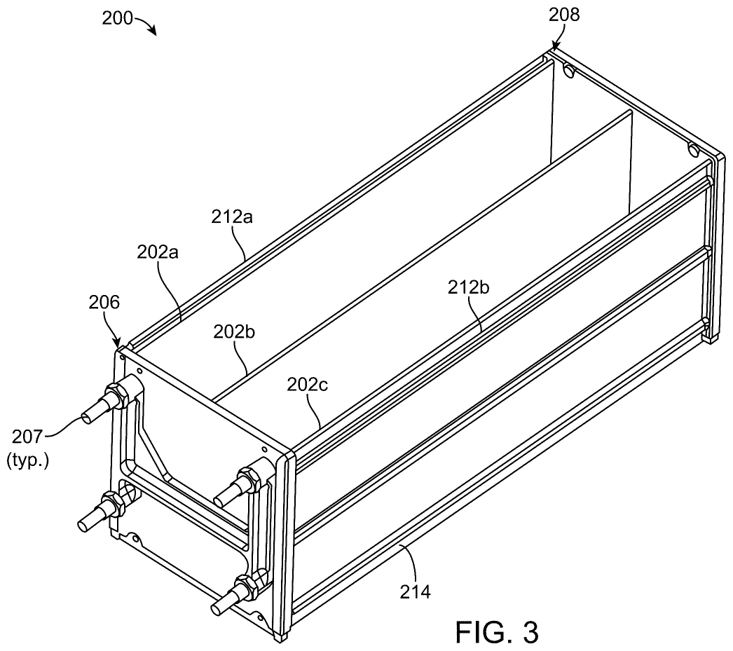

FIG. 2 depicts a cross-section of at least part of an example module chassis 200, in accordance with embodiments according to the present disclosure. FIG. 3 depicts a perspective view of at least part of the example module chassis 200, in accordance with embodiments according to the present disclosure. In some embodiments, the module chassis 200 (which may be referenced herein as a module chassis assembly) may correspond to one of the battery modules 132 of FIG. 1B. The module chassis 200 may include panels 202a, 202b, and 202c, which may correspond to a plurality of panels are arranged in parallel to one another. The panels 202a, 202b, and 202c may correspond to cold plate extrusions. In some embodiments, the panels 202a, 202b, and 202c may be formed with thin sheets of extruded aluminum. In some examples, each of the panels 202a, 202b, and 202c may be approximately a millimeter thick with a wall thickness of approximately 0.4 millimeters.

As illustrated in FIG. 2, each of the panels 202a, 202b, and 202c may be formed (e.g., by way of extrusion) to have channels 204 extending all the way through the panels 202a, 202b, and 202c. The channels 204 may correspond to longitudinal cavities adapted to allow fluid to pass through the plurality of channels from one end of a respective panel 202a, 202b, 202c to an opposite end of the respective panel 202a, 202b, 202c. In some embodiments, the module chassis 200 may be adapted to allow water (e.g., with additives) to flow through the channels 204. In some embodiments, the module chassis 200 may be adapted to allow any other suitable type of fluid to flow through the channels 204.

The module chassis 200 may include end plates 206 and 208. The end plate 206 may correspond to a module chassis front billet assembly. The end plate 208 may correspond to a module chassis rear billet assembly. The end plates 206 and 208 may be formed (e.g., machined) to have channels 210, similar to the longitudinal channels 204, to allow fluid to pass through the channels 210. The end plates 206 and 208, with channels 210, may be adapted to continue a fluid path when the end plates 206 and 208, with channels 210, are connected to the panels 202a, 202b, and 202c (e.g., by brazing) to make a fluid-tight fluid path. In some examples, the end plates 206 and 208 may be formed at least in part from aluminum.

The module chassis 200 may include side plates 212a and 212b and a floor panel 214 that are adapted to reinforce the panels 202a, 202b, and 202c and the end plates 206 and 208. The side plates 212a, 212b and the floor panel 214 may be formed from composite materials. Accordingly, the side plates 212a, 212b may correspond to composite shear panels, and the floor panel 214 may correspond to a composite floor panel. In some examples, the side plates 212a, 212b and the floor panel 214 may correspond to carbon fiber plates.

The side plates 212a, 212b and the floor panel 214 may be bonded in place to provide reinforcement necessary so the module chassis 200 can handle the load cases to which it may be subjected. Accordingly, the panels 202a, 202b, 202c; the side plates 212a, 212b; the end plates 206, 208; and the floor panel 214 may be a lightweight, single-piece structure that retains battery cells (e.g., 60 or more pouch cells) in a compressed state and that allows for fluid to run through the module chassis 200 to cool the battery cells. As such, the single-piece structure may correspond to a structural cold plate.

The module chassis 200 may include a plurality of legs 207 fixedly attached at the front of the module chassis 200. The legs 207 may facilitate structural mounting of the module chassis 200 to other components, such as a mounting plate assembly may include a DC/DC converter attached to the end plate 206 and other electronics and circuitry. Additionally, the mounting plate assembly may allow for fixing the module chassis 200 in the battery pack 100 and to other parts of an aircraft. Further, the module chassis 200 may include a plurality of legs 209 fixedly attached at the rear of the module chassis 200. The legs 209 may also facilitate the structural mounting of the module chassis 200 to other parts of the battery pack 100 and to other parts of an aircraft. The legs 207, 209 may be referenced as standoffs or studs. Together, the legs 207, 209 may support the structural load of the module chassis 200 and battery cells under high gravitational loads and impacts from hard landings experienced with aircraft.

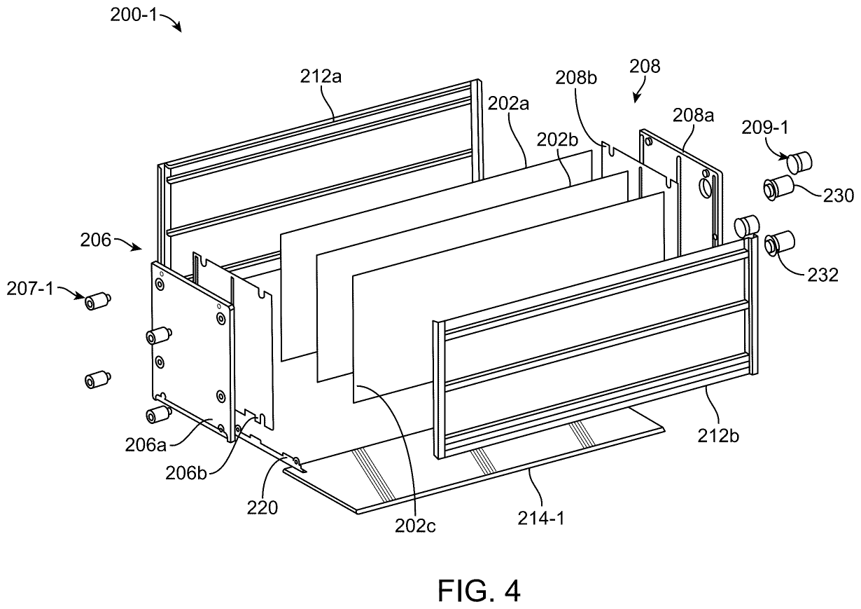

FIG. 4 illustrates a diagram of at least part of the module chassis 200-1, in accordance with embodiments according to the present disclosure. The diagram shows an exploded view of the module chassis 200-1 assembly. Illustrated are the panels 202a, 202b, 202c; the side plates 212a, 212b; the end plates 206, 208; and the floor panel 214, as well as module chassis front hard points corresponding to legs 207-1, module chassis rear hard points corresponding to legs 209-1, an inlet 230, an outlet 232 and a module chassis skid 220.

The module chassis 200 may be attached to the wider structure of the battery pack 100 via any suitable connections. In some examples, the module chassis 200 may be bolted two other components of the battery pack 100 via bolted connections at the front and the back of the module chassis 200. In some embodiments, the legs 207-1, 209-1 may be adapted to facilitate the connection.

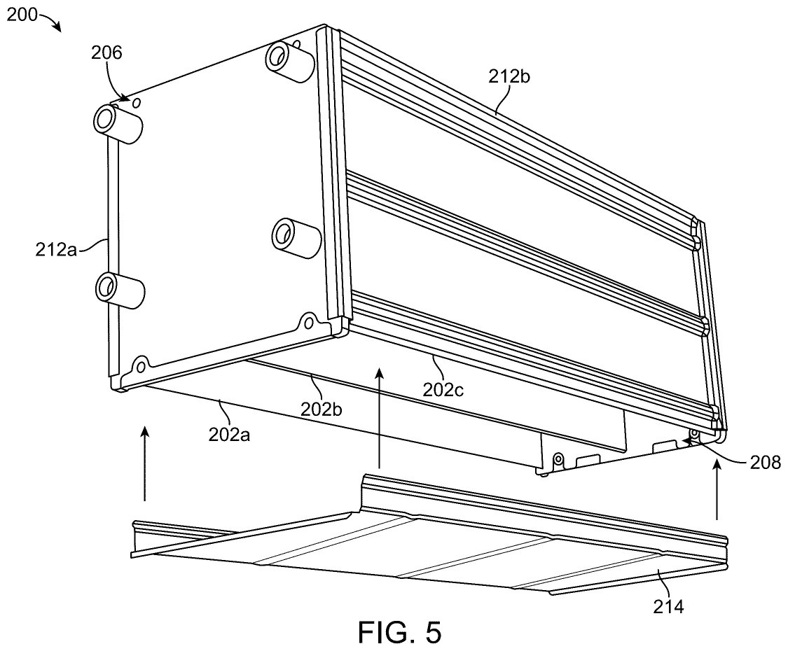

In addition to providing operational fluid cooling, the module chassis 200 may facilitate the structural load path based at least in part on supporting the cumulative battery cell mass via the floor panel 214. FIG. 5 illustrates another view of the module chassis 200 that emphasizes the floor panel 214 adapted to support the cumulative battery cell mass, in accordance with embodiments according to the present disclosure. In some embodiments, the floor panel 214 may be installed after the battery cells are populated in the module chassis 200 between the end plates 206, 208. In some embodiments, the floor panel 214 may be installed before the battery cells are populated in the module chassis 200 between the end plates 206, 208.

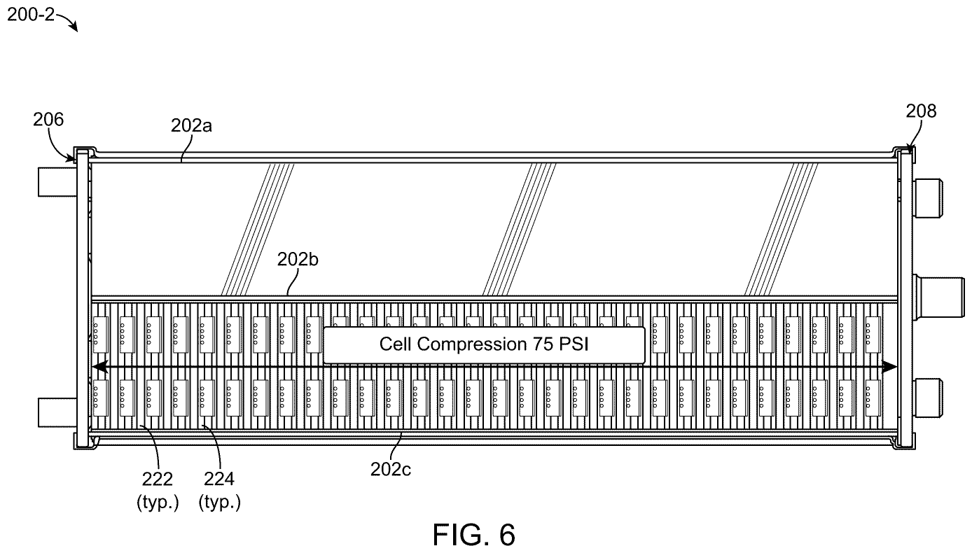

FIG. 6 illustrates a top view of an example module chassis 200-2 providing battery cell compression, in accordance with embodiments according to the present disclosure. FIG. 6 illustrates battery cells 222 in a compressed state. Pouch cells, for example, may need to be pushed on due to the cells'tendency to swell as the cells charge and discharge. Thus, the compression of the pouch cells may restrict the expansion of the pouch cells so the pouch cells do not destroy themselves.

The battery cells 222 may have foam inserts 224 in between them that are over-compressed to insert them into a fixed gap distance. Each of the foam inserts 224 may be engineered to act like a spring. The foam inserts 224 may then expand to apply cell compression. The combination of the battery cells 222 and the foam inserts 224 may be pretensioned when inserted inside the module chassis 200. In some examples, the cell compression may be in the range of 20 PSI to 75 PSI. Other compression values are possible. Accordingly, the module chassis 200 may integrate the function of resisting the pressure of the compressed battery cells 222 and foam inserts 224 with the functions of operational fluid cooling and providing structural support, all with a lightweight structure.

The end plates 206, 208 may be multipurposed. The end plates 206, 208 provide the structural support, cell structural load transfer, and cooling channels. Additionally, the end plates 206, 208 may correspond to end dams that provide cell compression. Referring again to FIG. 4, as illustrated, in some embodiments, the end plates 206, 208 may each be a combination of multiple plates. For example, the end plate 206 may be an assembly including billet plate 206a and billet plate 206b. The end plate 208 may be an assembly including billet plate 208a and billet plate 208b.

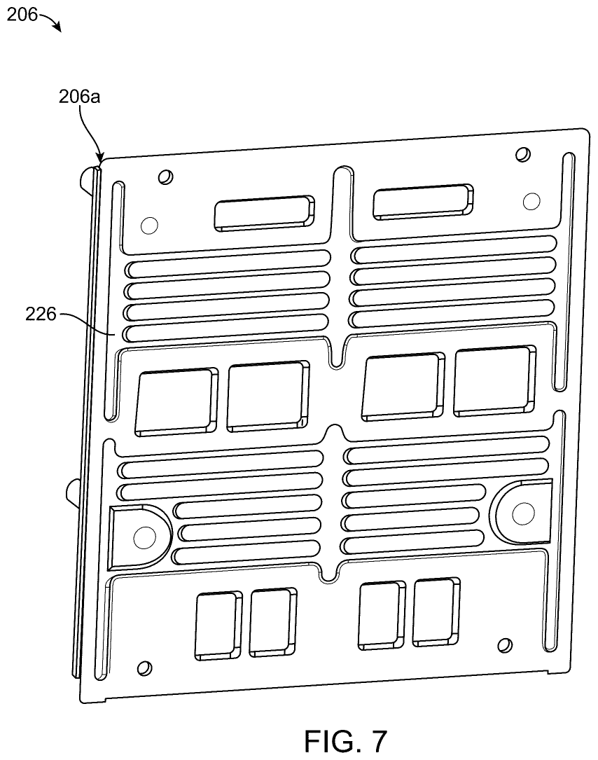

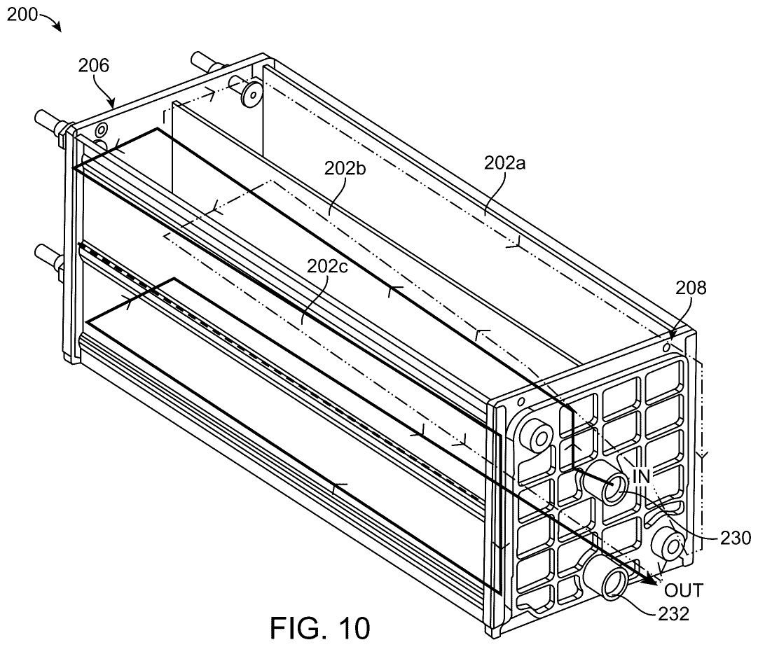

FIG. 7 illustrates the billet plate 206a of the end plate 206 assembly, in accordance with embodiments according to the present disclosure. The billet plate 206a may be formed to include channels 226 that, with the other billet plate 206b (not shown in FIG. 7, opposite from billet plate 206a), guide fluid to or from the channels 204 of the panels 202a, 202b, 202c (illustrated in FIG. 2). For example, as fluid flow through channels 204 of the center panel 202b and reaches the end plate 208 assembly, the fluid may enter one or more middle portions of the channels 226 and be guided by the channels 226 left and/or right toward the outer portions of the channels 226. From the outer portions of the channels 226, the fluid may be guided to the channels 204 of the outer panels 202a, 202c. Via the outer panels 202a, 202c, the fluid may flow toward the end plate 208. The flow of the coolant fluid is further described below in connection with FIG. 10.

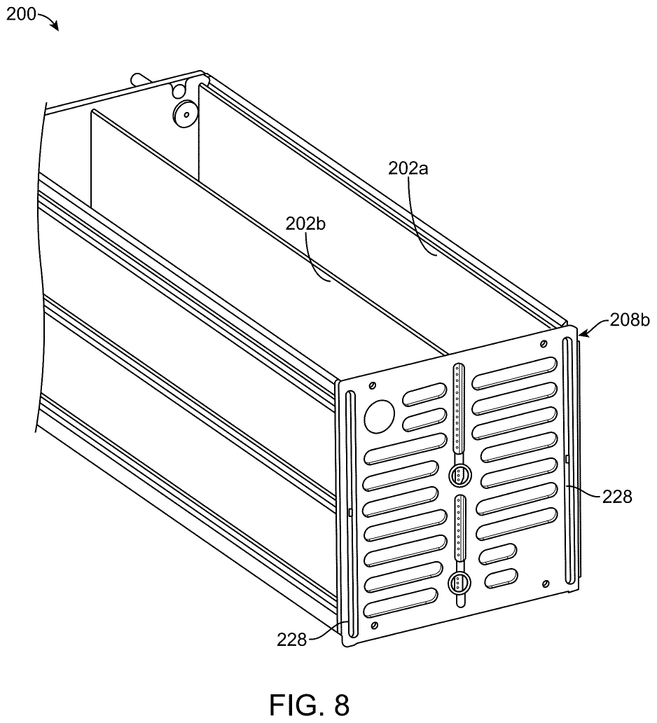

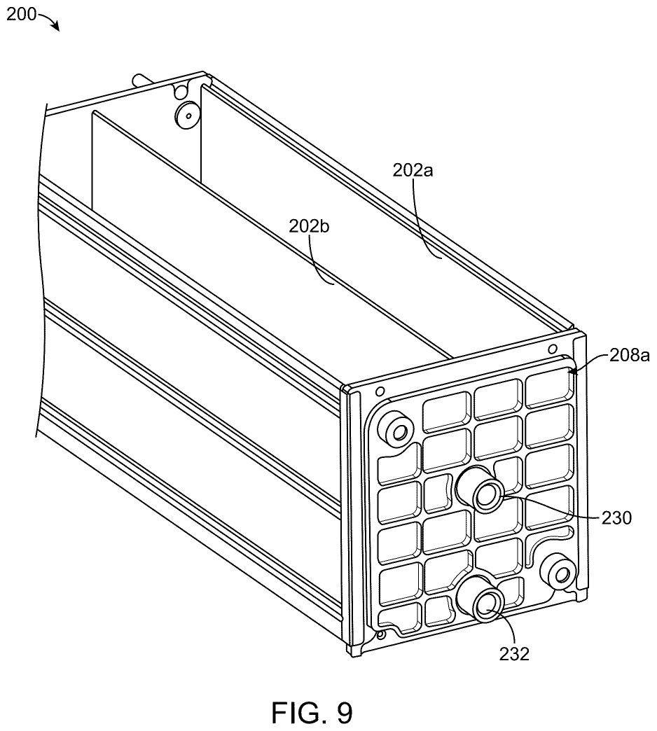

FIG. 8 illustrates another view of the module chassis 200 with the billet plate 208b of the end plate 208 assembly exposed, in accordance with embodiments according to the present disclosure. FIG. 9 illustrates a view of the module chassis 200 with the billet plate 208a attached, in accordance with embodiments according to the present disclosure. Fluid may enter the module chassis 200 via an inlet 230. Fluid may exit the module chassis 200 via an outlet 232.

When the fluid flowing via the outer panels 202a, 202c reaches the end plate 208, the fluid may enter the end plate 208 assembly via openings 228 of the billet plate 208b. Similar to the end plate 206 assembly, the billet plate 208b, together with the billet plate 208a, may form channels to guide the fluid through the end plate 208 assembly. Some of the fluid may be guided by the channels of the end plate 208 to exit the end plate 208 via the outlet 232. Some of the fluid may be guided by the channels of the end plate 208 to the panels 202a, 202b, and/or 202c.

FIG. 10 illustrates fluid paths through the module chassis 200, in accordance with embodiments according to the present disclosure. A fluid path may extend from the inlet 230 and wind around an upper portion of one of the volumes adapted to hold the battery cells 222 before winding around a lower portion of the volume. Fluid (e.g., cold water or another low-temperature coolant including a gas or gas mixture) may enter the inlet 230 and be guided by the end plate 208 to the upper subset of channels 204 of the middle panel 202b. As can be seen in the cross section of FIG. 2, the upper channels 204 of the middle panel 202b may be separated from the lower channels 204 of the middle panel 202b by a divider 216. The channels 204 of the outer panels 202a, 202c may likewise be formed to have the upper channels 204 segregated from the lower channels 204.

Referring again to FIG. 10, the fluid may flow through the channels 204 of the middle panel 202b to the end plate 206. The fluid may be generally bifurcated at the end plate 206 to flow back toward the end plate 208 via outer panels 202a, 202c. The end plate 206, with its channels, may guide the fluid generally laterally to the upper channels 204 of the outer panels 202a, 202c. The fluid may then flow through the upper channels 204 of the outer panels 202a, 202c back to the end plate 208. The end plate 202 may then guide the fluid down to the lower channels 204 of the outer panels 202a, 202c. The fluid may proceed through the lower channels 204 of the outer panels 202a, 202c back to the end plate 206. The end plate 206 may then guide the fluid to the lower channels 204 of the middle panel 202b. The fluid may then travel through the middle panel 202b back to the end plate 208 and out the outlet 232.

Accordingly, the module chassis 200 may provide for a serpentine fluid path. In some embodiments, the serpentine fluid path may include a bifurcated portion that splits the fluid from the inlet 230 and middle panel 202b to guide portions of the fluid through the outer panels 202a, 202c before recombining and guiding the portions to the outlet 232. Advantageously, the serpentine fluid path may minimize the temperature gradient across the battery cells. The battery cells can reject so much heat that the fluid picks up heat as it goes by the cells.

Conventionally, the battery cells furthest from coolant fluid do not get cooled as well due to the temperature gradient. The battery cells, being at different temperatures, perform differently because of internal resistance being temperature dependent. Therefore, the charging of the battery cells is limited by the hottest battery cell in the pack.

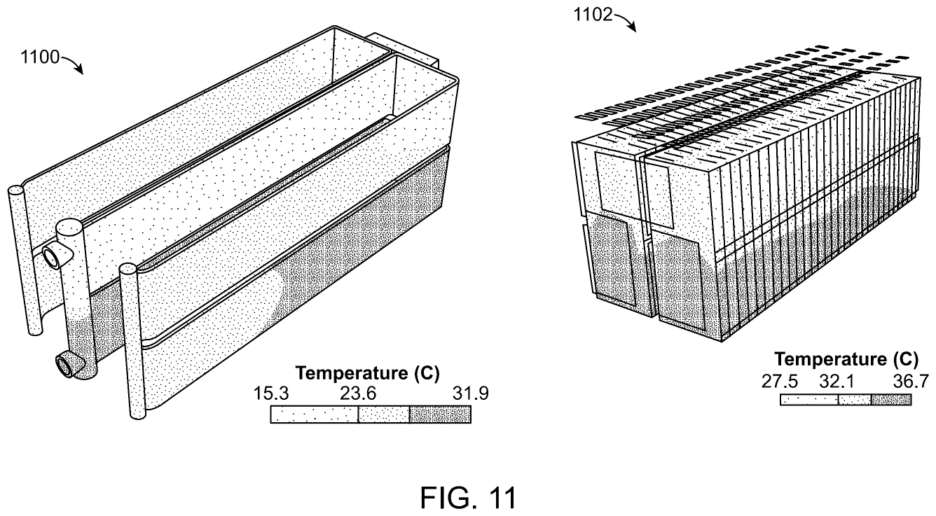

However, the module chassis 200 according to embodiments described herein may keep a very good temperature uniformity of all battery cells in the module because the serpentine flow path goes back and forth through the module in a way to ensure very low temperature gradients so that every cell from top to bottom is cooled evenly. FIG. 11 illustrates a model 1100 of the temperature contours of part of the cold plate assembly (panels 202a, 202b, 202c and end plates 206) and a model 1102 of the temperature contours of the battery cells, in accordance with embodiments according to the present disclosure. The fluid may pass by every battery cell four time, and, therefore, each battery cell may have four areas of heat-transferring contact with the cold plate assembly. For any one cell, those four areas of contact may have approximately the same average temperature. Thus, the battery cells may each have similar temperature gradients. Any element of chemistry within any cell anywhere in the battery may be within about 10° C. of every other element of chemistry in the battery.

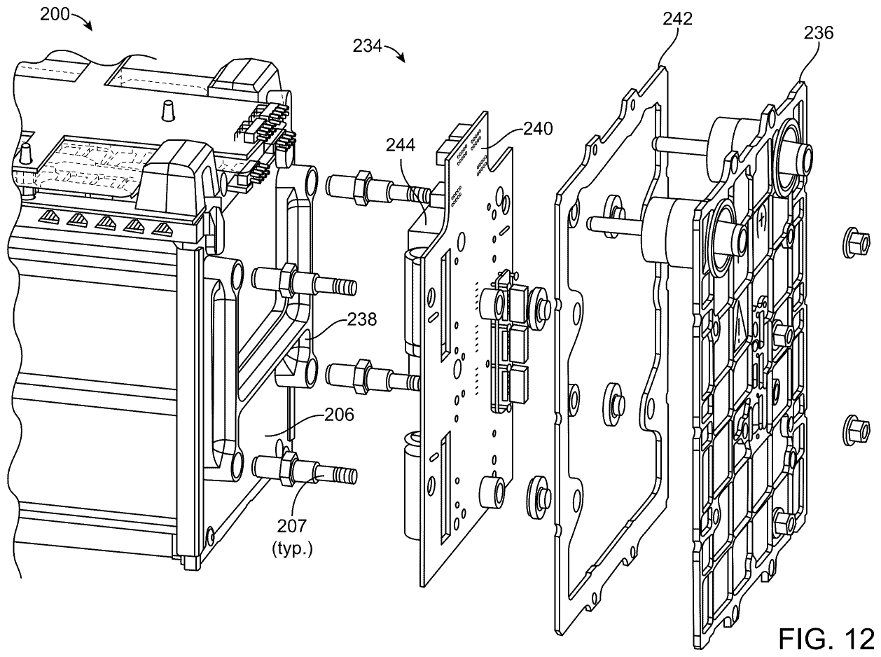

FIG. 12 illustrates a view of the front portion of the module chassis 200 with an exploded view of a front face assembly 234, in accordance with embodiments according to the present disclosure. As illustrated, the legs 207 may facilitate structural mounting of the module chassis 200 to a front face 236 of the front face assembly 234. The legs 207 may be attached to the end plate 206 via a bracket 238, each of which may be formed of titanium or another suitable material. The front face assembly 234 may include a circuit board 240 attachable to the front face 236 by way of a bracket 242 or any suitable means. The front face 236 may allow for connection to the wider battery structure. The legs 207 may correspond to load pins that allow for load to be transferred to the module casing via hard points to the front face 236 and the load pins.

Mounted on the circuit board 240 may be a DC/DC converter 244. The DC/DC converter 244 may be adapted to high voltage of the battery cells to a lower voltage. As such, the DC/DC converter 244 may be a LV generator. Accordingly, the battery module and the DC/DC converter 244 may provide for a HV/LV architecture. The DC/DC converter 244 may, in some embodiments, be adapted to power an electrical switch that electrically connects and disconnects the battery cells of the battery module. The DC/DC converter 244 may, in some embodiments, be adapted to output a lower voltage from the battery cells of the battery module that, in conjunction with the DC/DC converted lower voltage of other battery modules (e.g., five other battery modules), is used to power components of an aircraft, such as motors for propellers, wheels, etc.

Thus, each of a plurality of battery modules may have its own DC/DC converter 244. Accordingly, each module chassis 200 may integrate a DC/DC converter 244 at the module level. Disclosed embodiments of the HV/LV architecture may have the benefit of elevated failure tolerance with 72 independent LV sources. This is a level of redundancy that may be unmatched by other methods employed by traction applications when LV is generated at the pack level, usually one LV generator per HV battery stack. Disclosed embodiments may provide for a highly customizable design where any number of modules could be fitted with LV generators allowing for different configurations of LV architecture.

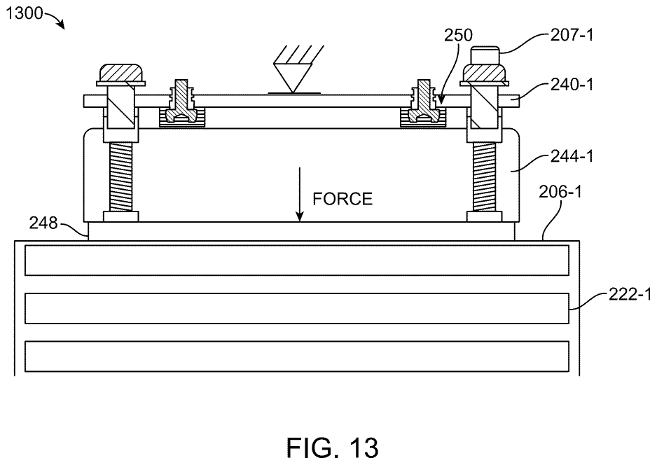

FIG. 13 is a diagram illustrating a cross-section of a spring-loaded mount assembly 1300 for mounting the DC/DC converter 244-1, in accordance with embodiments according to the present disclosure. The spring-loaded mount assembly 1300 may ensure that the DC/DC converter 244-1 is always rigidly attached and pressured up against the end plate 206-1 of the module chassis 200. The DC/DC converter 244-1 may abut a thermal pad 248. The thermal pad 248 may be disposed between the DC/DC converter 244-1 and the end plate 206-1. The circuit board 240-1 may be rigidly fixed to the end plate 206-1. For example, the circuit board 240-1 may be bolted to the end plate 206-1 via the legs 207-1. Spring-loaded mounts 250 may be attached to the circuit board 240-1 and mounted to the DC/DC converter 244-1 so that the spring-loaded mounts 250 apply force on the DC/DC converter 244-1 in a distributed manner. Accordingly, the force applied by the spring-loaded structure may provide for a tight fit of the DC/DC converter 244-1 against the thermal pad 248 (e.g., ensuring that the thermal pad 248 is always crushed) and against the end plate 206-1 via the thermal pad 248. With this approach, the DC/DC converter 244-1 may be allowed to expand and contract and move slightly while the springs always ensure a positive engagement with the end plate 206-1. Otherwise, with a conventional bolted connection, the DC/DC converter 244-1 may eventually work its way apart from the end plate 206-1 with the heating, cooling, and jostling of the assembly with an aircraft.

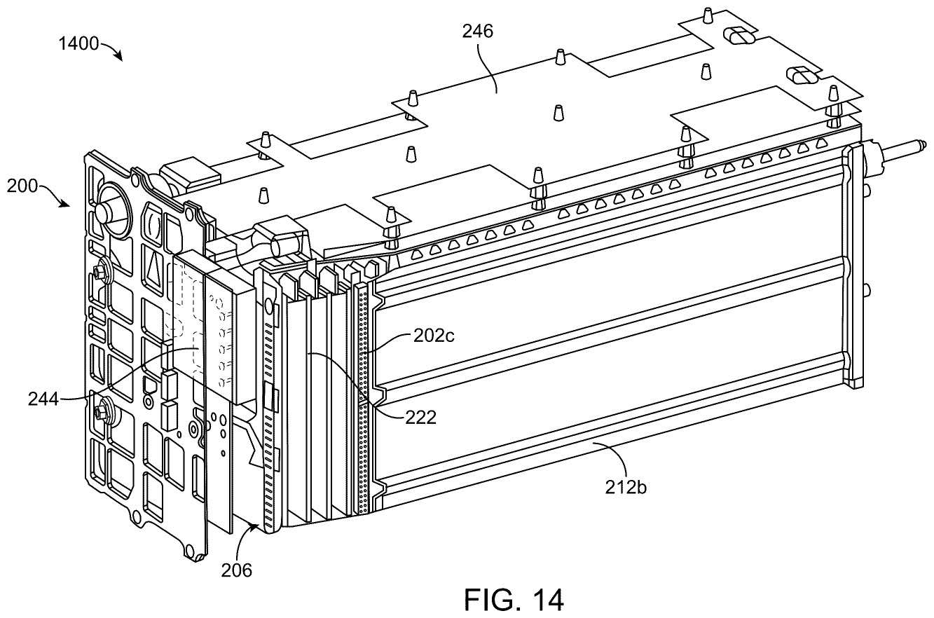

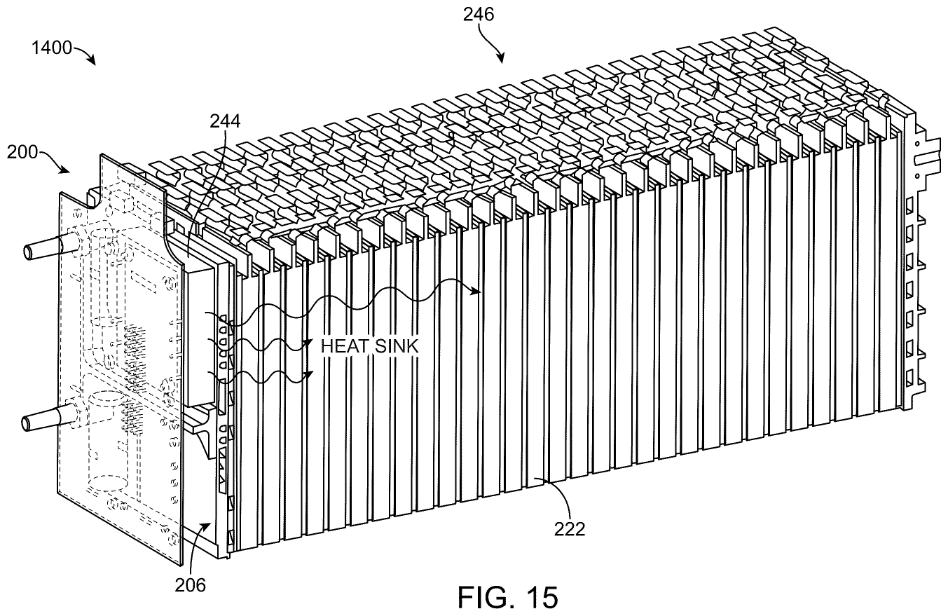

FIG. 14 illustrates a partial cross-section view of a battery module assembly 1400, in accordance with embodiments according to the present disclosure. FIG. 15 illustrates another partial cross-section view of a battery module assembly 1400, in accordance with embodiments according to the present disclosure. The battery module assembly 1400 may include the module chassis 200, the battery cells 222, and one or more electronic components such as the DC/DC converter 244. The module chassis 200 is illustrated with a transparent front face assembly 234 to reveal the DC/DC converter 244. The DC/DC converter 244 may be attached to the module chassis 200 in any suitable manner. In some embodiments, the DC/DC converter 244 may be attached to the end plate 206 via a spring-loaded bolt configuration, which may be a part of the front face assembly 234. A thermal conduction pad (not shown) may be disposed between the DC/DC converter 244 and the end plate 206 to provide a robust heat path.

Heat (indicated in FIG. 15) from operation of the DC/DC converter 244 may flow directly from the DC/DC converter 244 through the thermal pad and thermally conductive module chassis 200, with the module chassis 200 functioning as a heat spreader to be distributed more or less evenly amongst the battery cells 222, increasing the temperature of the battery cells 222. The battery cells 222 may store heat energy during flight and may be subsequently cooled via the fluid jacket that is built into the module chassis 200 during charging of the battery cells 222. Advantageously, sinking heat into the cells 222 allows for heat dissipation with no separate heat dissipation system and no additional parts, leading to lower mass and volume as no parts are added for thermal management and the prevention of thermal damage to the DC/DC converter 244 and/or other components. The module chassis 200 may not only cool the battery cells 222 but also the DC/DC converter 244, acting as a heat spreader for the DC/DC converter 244. With such embodiments, there is no need for DC/DC converters to be in separate enclosures that each require dedicated, dual-redundancy active cooling systems (e.g., pump systems), as may be done conventionally, which results in higher weight and greater space requirements. Thus, the module chassis 200 may provide the additional function of cooling the DC/DC converter 244 and/or other components, that is, in addition to providing cell compression, a structural load path, and operational cooling of the battery cells 222.

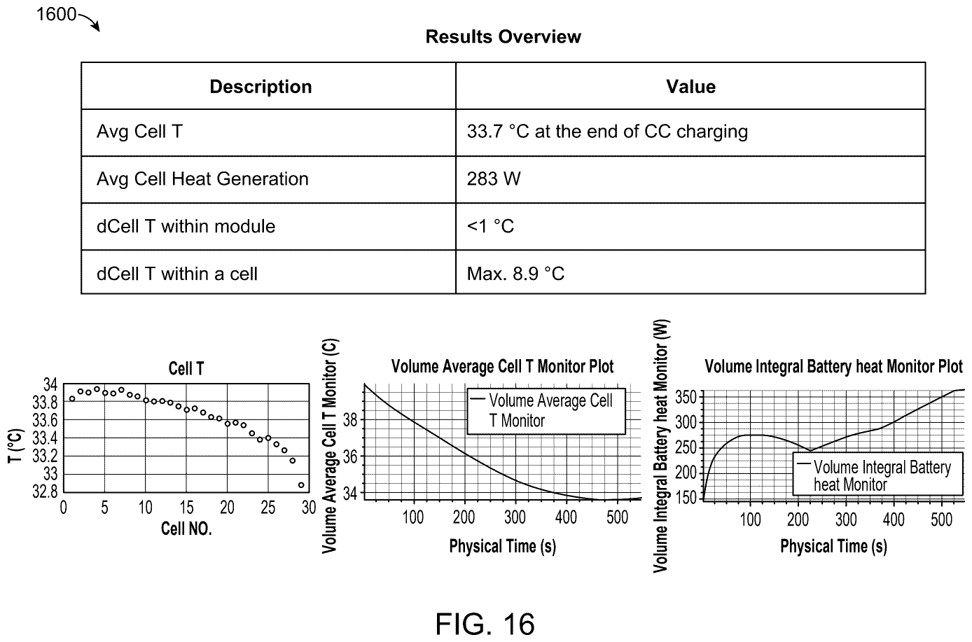

FIG. 16 illustrates example test results 1600 for the battery module assembly 1400 during charging, in accordance with embodiments according to the present disclosure. As demonstrated by the test results 1600, even with the cooling of the DC/DC converter 244 and the heat distribution to the battery cells 222 through the conductive end plates 206, 208, and panels 202a, 202b, and 202c, any element of any cell 222 may be within approximately 10° of any other element of any cell 222. The thermally conductive (e.g., aluminum) end plates 206, 208, and panels 202a, 202b, and 202c may provide high conduction and wide/even distribution of the heat via the extrusion panels 202a, 202b, and 202c throughout the module chassis 200 so that every cell stays within a temperature limit of 10° delta, for example. The cell mass of the battery cells 222 may provide for high heat storage capacity (e.g., 500 kgs or more of mass for the battery cells 222 in one module chassis 200, with large amounts of copper, aluminum, and lithium and iron oxide in the cells 222 that can absorb the heat energy). The cooling fluid (e.g., water with glycol) within the channels of the module chassis 200, though static when the battery cells 222 are discharging (e.g., during operation of the vehicle), may also absorb the heat with a much higher heat capacity that the end plates 206, 208, and panels 202a, 202b, and 202c.

The cells 222 may heat up themselves naturally when they are discharging and when they are being charged, but they may get hotter when they are being charged versus discharged. Much more low voltage power may be needed during discharge, for example, when the aircraft is flying because all of the onboard computers and surface components may rely on the low voltage (e.g., 28 V). The integrity of the voltage supply may be flight critical. Thus, embodiments may ensure that the low voltage bus has the highest degree of reliability and redundancy with, for example, 72 independent generations of 28 V at the module level.

Further adding to the reliability may be the elimination of the need for active cooling of the DC/DC converter 244. With the module chassis 200, the DC/DC converter 244 may be passively cooled. The active fluid cooling of the module chassis 200 via the pump-driven fluid through the channels disclosed above may be employed when the battery cells 222 are being charged (e.g., only during the charging process), which would happen when, for example, an aircraft powered by the battery cells 222 is grounded. Thus, the active fluid cooling may be employed when the cells would otherwise tend to get the hottest. However, the passive cooling of the DC/DC converter 244 may occur when the battery cells 222 are being discharged, for example, when the aircraft is being operated. Then, again, after flight, the battery cells 222 may again be reset with charging and cooling with the fluid cooling of the module chassis 200.

Actively cooling would require an active cooling circuit and, if the pump fails, overheating and loss of operation can result—a scenario that requires dual redundancy of pump systems. However, with the DC/DC converter 244 integrated with the module chassis 200 and having a sufficient thermal connection to the module chassis 200 according to the embodiments described herein, the heat path may not be destroyed, interrupted, or degraded. The module chassis 200, with the battery cells 222, may have sufficient heat storage capacity to absorb the energy. As shown, for example, through modelling with every circumstance from takeoff to touchdown, every emergency load case, and every corner case, there may always be enough thermal mass that the DC/DC converter 244 may never overheat, while all the cells 222 may be within 10° of each other.

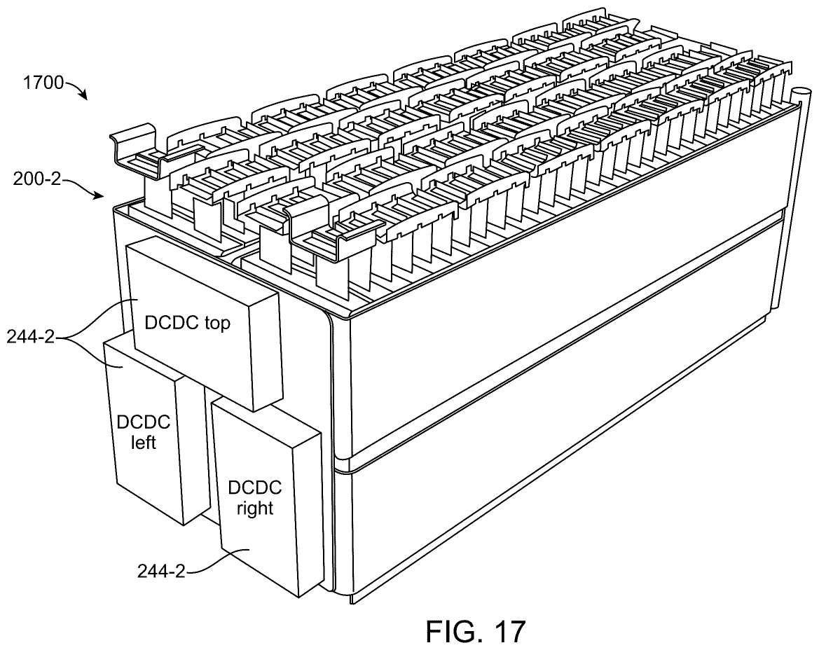

FIG. 17 illustrates alternative DC/DC converter implementations with a battery module assembly 1700, in accordance with embodiments according to the present disclosure. In alternative embodiments, multiple DC/DC converters 244-2 may be used instead of the one DC/DC converter 244. For example, two or three DC/DC converters 244-2 that together provide the function of the DC/DC converter 244 may be employed and disposed, for example, in thermal contact with the end plate 206.

In some embodiments, the DC/DC converter 244 may be positioned as shown in FIG. 14. The DC/DC converter 244 may be disposed at an upper portion of the end plate 206 so as to be proximate to the upper portions of the cells 222, which tend to stay cooler. As illustrated by model 1102 of FIG. 11, the cells 222 may not heat up evenly but tend to get hotter at their lower portions due to their internal mechanics. In other embodiments, the DC/DC converter 244 may be positioned elsewhere on the module chassis 200. For example with respect to FIG. 17, the DC/DC converters 244-2 alternative positions and orientations.

Referring again to FIG. 14, the use of the module chassis 200 for cooling power components may not be limited to the thermal management of the DC/DC converter 244. Various embodiments may provide for passively cooling various components. For example, the module chassis 200 may include a battery management system (BMS) board 246 attached to the top of the module chassis 200. The BMS board 246 may be configured to monitor temperature and voltage and then balance the cells 222. The BMS board 246 may correspond to another circuit board (e.g., a PCB) with various electronic components, that is, heat sources that may be cooled with module chassis 200. The BMS board 246 may be passively cooled by the module chassis 200, rather than being in a separate enclosure and requiring dual redundancy active cooling systems. In some embodiments, an additional panel (not shown) like panels 202a, 202b, 202c may be added as a top panel, and thermal pads for contacting the panel may be used to ensure sufficient thermal connections of the electronic components with the panel. Other embodiments are possible.

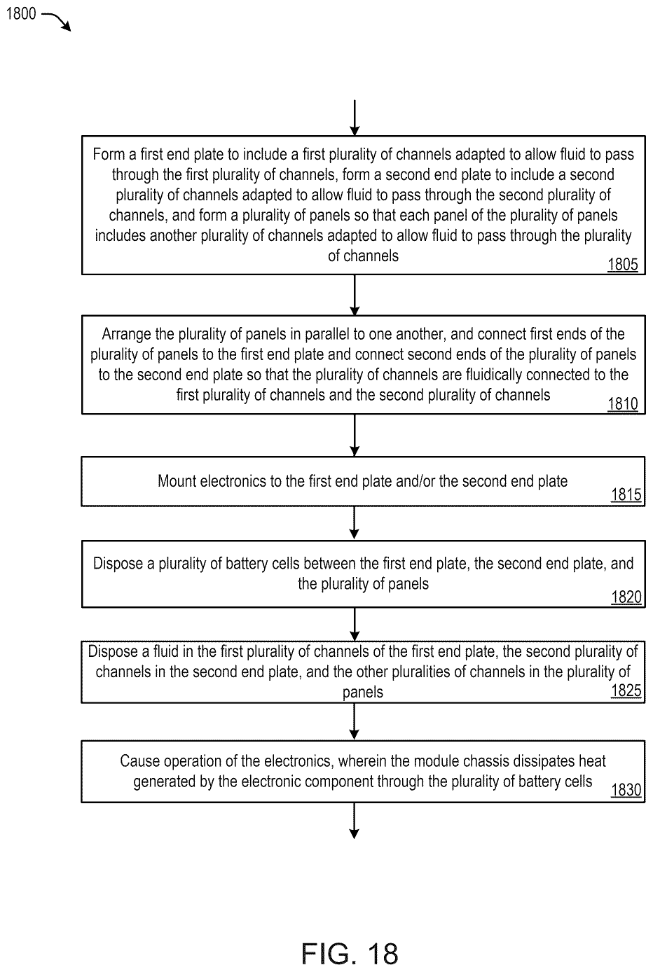

FIG. 18 illustrates one example method 1800 of forming a module chassis assembly and dissipating heat generated by electronics with the module chassis assembly, in accordance with embodiments according to the present disclosure. One or a combination of the aspects of the method 1800 may be performed in conjunction with one or more other aspects disclosed herein, and the method 1800 is to be interpreted in view of other features disclosed herein and may be combined with one or more of such features in various embodiments. Teachings of the present disclosure may be implemented in a variety of configurations that may correspond to the configurations disclosed herein. As such, certain aspects of the methods disclosed herein may be omitted, and the order of the steps may be shuffled in any suitable manner and may depend on the implementation chosen. Moreover, while the aspects of the methods disclosed herein, may be separated for the sake of description, it should be understood that certain steps may be performed simultaneously or substantially simultaneously.

As indicated by block 1805, a first end plate (e.g., end plate 208) may be formed to include a first plurality of channels (e.g., channels 210) adapted to allow fluid to pass through the first plurality of channels. A second end plate (e.g., end plate 206) may be formed to include a second plurality of channels (e.g., channels 226) adapted to allow fluid to pass through the second plurality of channels. A plurality of panels (e.g., panels 202a, 202b, 202c) may be formed so that each panel of the plurality of panels includes a plurality of channels (e.g., channels 204) adapted to allow fluid to pass through the plurality of channels. In some examples, the end plates and panels may be formed at least in part by extruding aluminum.

As indicated by block 1810, the plurality of panels may be arranged in parallel to one another. First ends of the plurality of panels may be connected to the first end plate and second ends of the plurality of panels may be connected to the second end plate so that the plurality of channels are fluidically connected to the first plurality of channels and the second plurality of channels. In some examples, the first end plate, the second end plate, and the plurality of panels may be bonded together in the arrangement disclosed herein via welding, brazing, soldering, gluing, fastening, and/or the like.

A first plurality of legs (e.g., legs 207) may be fixedly attached to the first end plate. A second plurality of legs (e.g., legs 209) may be fixedly attached to the first end plate. In some examples, the legs may be formed from titanium or another suitable material. Again, in some examples, the legs may be bonded to the end plates by way of welding, brazing, soldering, gluing, fastening, and/or the like.

Side plates (e.g., plates 212a, 212b) and a floor panel (e.g., 214) may be formed and arranged to reinforce the endplates and the plurality of panels. In some examples, the side plates and floor panel may be formed from a composite material or another suitable material. In some examples, the side plates and floor panel may be bonded together and to the end plates (and, in some embodiments, the panels) via welding, brazing, soldering, gluing, fastening, and/or the like.

As indicated by block 1815, electronics (e.g., one or more DC/DC converters) may be mounted to the first end plate and/or the second end plate in any suitable manner. For example, electronics may be attached to the first end plate and/or the second end plate by way of one or more of the first plurality of legs and/or the second plurality of legs.

As indicated by block 1820, a plurality of battery cells may be disposed between the first end plate, the second end plate, and the plurality of panels. As indicated by block 1825, fluid may be disposed in the first plurality of channels of the first end plate, the first plurality of channels of the second end plate, and the other pluralities of channels of the plurality of panels. As indicated by block 1830, the electronics may be caused to operation, and the module chassis may dissipate heat generated by the electronics through the plurality of battery cells.

While embodiments have been described with reference to specific embodiments, those skilled in the art with access to this disclosure will appreciate that variations and modifications are possible. It should be understood that all numerical values used herein are for purposes of illustration and may be varied. In some instances, ranges are specified to provide a sense of scale, but numerical values outside a disclosed range are not precluded.

It should also be understood that all diagrams herein are intended as schematic. Unless specifically indicated otherwise, the drawings are not intended to imply any particular physical arrangement of the elements shown therein, or that all elements shown are necessary. Those skilled in the art with access to this disclosure will understand that elements shown in drawings or otherwise described in this disclosure may be modified or omitted and that other elements not shown or described may be added.

The above description is illustrative and is not restrictive. Many variations will become apparent to those skilled in the art upon review of the disclosure. The scope of patent protection should, therefore, be determined not with reference to the above description, but instead should be determined with reference to the following claims along with their full scope or equivalents.

What is claimed:

1. A battery module assembly comprising:
a module chassis comprising:
a first end plate;
a second end plate; and
a first panel and a second panel arranged in parallel to one another, wherein first ends of the first panel and the second panel are connected to the first end plate, and second ends of the first panel and the second panel are connected to the second end plate;
wherein the module chassis is adapted to hold a first plurality of battery cells between the first end plate, the second end plate, the first panel, and the second panel; and
an electronic component abutted against the module chassis, wherein the module chassis is adapted to dissipate heat generated by the electronic component through the first plurality of battery cells.

2. The battery module assembly as recited in claim 1, further comprising a thermal pad disposed between the electronic component and the module chassis.

3. The battery module assembly as recited in claim 1, further comprising a spring-loaded mount assembly adapted to apply force to the electronic component to keep the electronic component abutted against the module chassis.

4. The battery module assembly as recited in claim 3, wherein the spring-loaded mount assembly is further adapted to keep the electronic component abutted against the module chassis while allowing the electronic component to expand or contract.

5. The battery module assembly as recited in claim 3, wherein the spring-loaded mount assembly comprises a plurality of spring-loaded mounts that facilitate distributing the forces on the electronic component.

6. The battery module assembly as recited in claim 1, wherein the electronic component is a low-voltage generator.

7. The battery module assembly as recited in claim 1, wherein the electronic component is a direct-current-to-direct-current (DC/DC) converter.

8. The battery module assembly as recited in claim 1, wherein the electronic component is a component of a battery management system.

9. The battery module assembly as recited in claim 1, wherein the electronic component is abutted against the first end plate of the module chassis.

10. The battery module assembly as recited in claim 9, wherein the electronic component is abutted against an upper portion of the first end plate.

11. The battery module assembly as recited in claim 9, wherein the electronic component is abutted against a lower portion of the first end plate.

12. The battery module assembly as recited in claim 1, wherein the module chassis comprises a plurality of channels adapted to hold fluid, wherein the fluid absorbs some of the heat generated by the electronic component.

13. The battery module assembly as recited in claim 12, wherein the first end plate comprises a first subset of the plurality of channels, the second end plate comprises a second subset of the plurality of channels, the first panel comprises a third subset of the plurality of channels, and the second panel comprises a fourth subset of the plurality of channels; and the first subset, the second subset, the third subset, and the fourth subset are fluidically connected.

14. The battery module assembly as recited in claim 1, further comprising a third panel arranged in parallel to the first panel and the second panel and connected to the first end plate and the second end plate.

15. The battery module assembly as recited in claim 18, wherein the module chassis is adapted to hold a second plurality of battery cells between the first end plate, the second end plate, the third panel, and the first panel or the second panel.

16. The battery module assembly as recited in claim 15, wherein the module chassis is adapted to dissipate some of the heat generated by the electronic component through the second plurality of battery cells.

17. The battery module assembly as recited in claim 15, wherein the first plurality of battery cells are disposed in parallel to the second plurality battery cells.

18. The battery module assembly as recited in claim 17, wherein the module chassis is adapted to hold the first plurality of battery cells and the second plurality of battery cells in a state of compression.

19. The battery module assembly as recited in claim 1, further comprising one or more legs coupled to the first end plate or the second end plate, the one or more legs adapted to facilitate mounting of the electronic component.

20. A method of dissipating heat generated by an electronic component, the method comprising:
disposing a plurality of battery cells in a module chassis, wherein the module chassis comprises a first end plate, a second end plate, and a plurality of panels arranged in parallel to one another, and wherein first ends of the first panel and the second panel are connected to the first end plate, and second ends of the first panel and the second panel are connected to the second end plate;
mounting an electronic component on the first end plate or the second end plate;
disposing fluid in a plurality of channels of the first end plate, the second end plate, and the plurality of panels;
causing operation of the electronic component, wherein the module chassis dissipates heat generated by the electronic component through the plurality of battery cells.
